(19) United States
(12) Patent Application Publication
(10) Pub. No.: US 2012/0290486 A1
(43) Pub. Date: Nov. 15, 2012

(54) AUTOMATED METHOD AND SYSTEM FOR INTERACTIVE COMPULSORY REPORTING OF LEASE APPLICATION ADJUDICATION DECISIONS, ONGOING TENANCY HISTORIES AND DEBTOR COLLECTIONS

(76) Inventors: John M. Dobrowolski, Toronto (CA); Brenda J. Maxwell, Arnprior (CA)

(21) Appl. No.: 13/467,202

(22) Filed: May 9, 2012

Related U.S. Application Data
(60) Provisional application No. 61/483,788, filed on May 9, 2011.

(51) Int. Cl. G06Q 10/00

(52) U.S. Cl. 705/307

(57) ABSTRACT

A method, system and related program and user interface for collecting residential and commercial tenancies information for the purpose of enriching a database of leasing decisions, rent tradelines, tenancy histories and tenant based social network is provided. Any tenancy application process requiring a system program to track post tenancy application events and collections can employ this method and business model. Mandatory interactive reporting of a plurality of application adjudication decisions for applicant verification and credentialing include move in, automated collection of good standing tenancies, monthly manner of payment histories, tenancy violations such as all types of termination matters, legal actions to terminate a tenancy, collections and enforcement to final move out status.

### CROSS REFERENCE

This application claims the benefit of U.S. provisional patent application No. 61/483,788 filed May 9, 2011, which is incorporated herein by reference.

### TECHNICAL FIELD

The present disclosure relates to tenancy property management and more particularly to methods and systems for compiling and maintaining tenancy history and other related data, for example, for computing and utilizing a tenancy history score with which to perform tenancy application adjudication.

### BACKGROUND

Tenancy property management relates to the granting of tenancy to a tenant in relation to a specific rental property. A prospective tenant (an applicant) applies for tenancy and in accordance with one or more business processes; a property manager gathers data and adjudicates (i.e. makes a determination) whether to grant tenancy. If a determination to grant is ultimately made, typically a lease and other documents are written and executed. The lease provides for periodic payments from the tenant.

During the term of tenancy, for each payment period the tenant may or may not make the payment on time. Tenancy may be terminated for various reasons. Other tenancy related events (e.g. debt owed, debt collected, etc.) might be occasioned, whether before or after tenancy is terminated.

As described further in one of the co-inventors' earlier filed and related U.S. patent application (Ser. No. 13/285,478 filed Oct. 31, 2011 and entitled “Method And System For Computerized Tracking, Analyzing And Reporting Of Information Specific To Residential And Commercial Tenancy Histories” which is incorporated herein by reference (hereinafter “the '478 patent application”)), when compared to the myriad of management tools used by the credit granting industry rental property businesses lack such similar system tools specifically designed to manage the credit of granting tenancies. The tool of choice is credit reports when selecting tenancy applicants. The integrating of payment history for loans and credit in general and delinquencies creates the basis for credit scoring models found in credit information from credit bureaus. Since landlords presently use credit reports during adjudication of tenancy applications it is clear that this is a flawed system and misrepresents the true measure of tenancy worthiness for a consumer who is a renter.

The '478 patent application proposes the compilation of tenancy related data to define a tenancy history for particular tenants and further provides a model for analyzing, scoring and weighting of such history data to create standard tenancy ratings, and rent-scoring for particular tenants. This tenancy history data and scoring may be useful to adjudicate a subsequent application by a prospective tenant, for example, when the tenant desires to move to a new property.

### SUMMARY

Therefore, it is desired to provide a property management tool for compiling tenancy related data to define a tenancy history for particular tenants and to provide interfaces to present such information.

There is provided a computer-implemented method and system for compiling data representing tenancy related events to define a tenancy history for a particular tenant. The method and system may be integrated into a tenancy property management system for adjudicating tenancy grants. Such as a tenancy property management system may include a function for obtaining data to make such a determination, where the data may comprise tenancy history and/or score, credit history and/or score, etc.

A graphical user interface facilitates the capturing of the data representing tenancy related events. Email and other communication tools may be used to trigger actions by users (e.g. property managers) to periodically update system defaulted data. The GUI may be configured to visually represent tenancy history for particular tenants.

To address the inherent reluctance by a vast number of landlords to report tenancy history, a method of automating updates of a tenant's total experiences with a landlord is devised. Depending on tracking requirements by the user a flexible system program and method provides for detailed to very minor to no entry from a user. The program and method creates automated updates of a tenant's good history by default. The compulsory nature of the system program and method requires users to opt in to providing default information about the manner in which monthly paying tenants honor their obligations. A graphical user interface is designed for quick and easy entry of all lease violations, and the reason and status of the tenancy when the renter moves out.

In one embodiment, payment history data processing performs updates by sending a notification email to the landlord (e.g. property manager) on the 6th day after the payment due date in each payment period including the first period of tenancy. On this 6^{th} day and for this particular payment period the notification extends to all registered users and their respective properties and all their tenants who have the same payment due date in the system are collectively updated to good standing. The notification email about the good standing reporting update is sent to the property manager user who can modify the update if a tenant is in default. The property manager user can accept the update by ignoring the email or click a link to log in to the system through a control panel of a user interface and report a default event.

A cascade of mini pop-up windows makes it quick and easy for entering delinquent information so these events can be tracked. There are two methods of entering events: short and long form. By clicking a corresponding box, a mini pop-up window with a menu appears that shows a selection of action options. Selecting an action option opens (invokes) the related action in the system. Depending on the selection, a short or long form for entering events is opened. Subsequent selections open further mini windows with detailed items in a drill down fade previous window and focus the opened window technique. To rapidly enter an event a quick entry menu list is provided and upon selection of an item the user completes the entry in two clicks for short form entries. A more full and flexible entry form system for more detailed entries with auto filled form fields is also provided.

Selecting a more detailed long form entry item on the mini menu allows for more information to be entered when specific legal notices and forms are desired to issue a court form, notice or produce printed forms.

As a matter of course rental property businesses conduct thousands of credit and other background searches on prospective tenants daily. Capturing the results of adjudicating applications, the date an approved search was conducted and a successful bureau report was delivered to the user is critical to the operation of this system program and method. Then the follow on date when a current tenant's information was reported by a landlord to the system program and method for the purpose of tracking date paid versus date due of tenant's reported weekly, bi-weekly or monthly period is vital to the operation of the system program and method.

### BRIEF DESCRIPTION OF FIGURES

The description herein may be understood with reference to the drawings in which:

FIG. 1 is a schematic view of general components and workflow manifested in a graphical user interface system, method and business model in accordance with one embodiment;

FIG. 2 is a schematic view showing tenancy related events captured as tenancy history data in accordance with one embodiment;

FIG. 3 shows a screenshot graphical representation of a user interface (e.g. Web form) to allow users to enter personal information to conduct a consumer and/or a commercial background search;

FIG. 4 shows a screenshot graphical representation of a user's property management software system depicting the integration of credit and tenancy checking;

FIG. 5 illustrates a system-to-system configuration in accordance with one embodiment;

FIG. 6 shows a screenshot graphical representation of a sample screen from a from a user's property management software system depicting the common practice of entering lease decisions such as Approved, Declined or Pending;

FIG. 7 shows a screenshot graphical representation of a user interface (an adjudication interruption window) that pops up when unresolved adjudication is detected upon user sign on;

FIG. 8 shows a screenshot graphical representation of a user interface (e.g. a pull-down menu aid) for selecting status type to view records and create management adjudication reports;

FIG. 9 shows operations for performing mandatory adjudication reporting to the tenancy information system in accordance with one embodiment;

FIG. 10 shows a graphical representation of a main control page and how the mini menu pop-ups generally function in accordance with one embodiment; and

FIG. 11 shows operations for debtor monitoring and email notification of the system in accordance with one embodiment.

### DETAILED DESCRIPTION

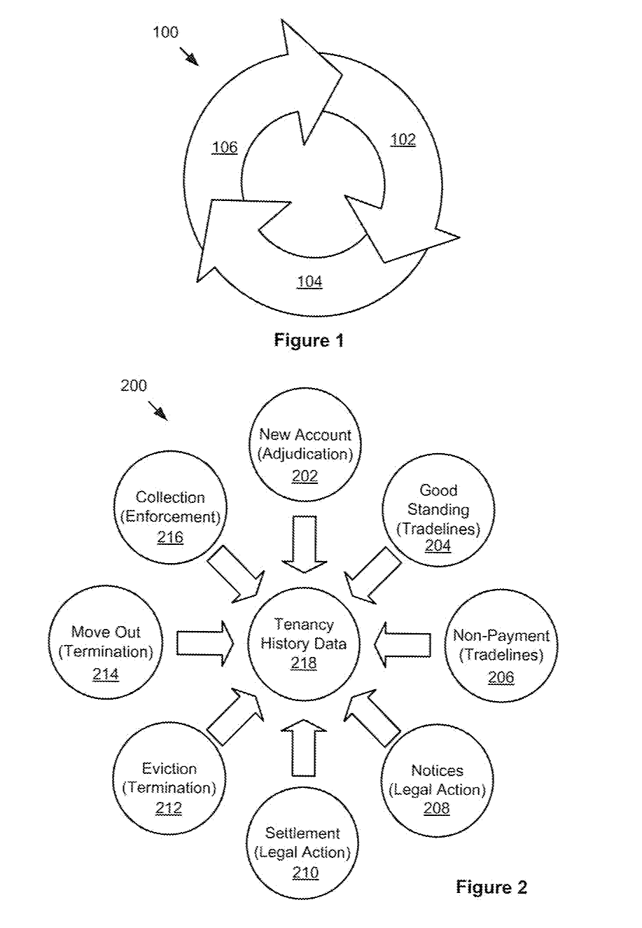

FIG. 1 is a schematic view 100 of general components and workflow manifested in an interactive tenancy information graphical user interface system, method and business model in accordance with one embodiment. A consumer and commercial searches component 102 provides an interface to receive requests for and to provides responses comprising one or more types (or combinations) of credit, tenancy, criminal or general background checks for customer information verification and credentialing. Such searches are often performed in association with a new tenancy application for information about a tenant. The new tenancy application comprises gathering applicable information and determining (adjudicating) whether to rent/lease to the tenant. A mandatory adjudication component 104 is provided to assist with the adjudication to rent and the configuring of the interactive tenancy information graphical user interface system to receive tenancy history data for the tenant. In the present embodiment, the inputting of an adjudication result for a new application is enforced as described herein below. A compulsory tenancy history reporting component 106 provides an interface to receive the tenancy history data as described further. Though illustrated as a cycle, it will be understood that operations of components may overlap. For example, operations of component 106 may be gathering tenancy history data for a tenant in relation to property A. The tenant may initiate an application to rent property B. Components 102 and 014 may operate in respect of the new application relative to property B before the tenant moves out of property A.

FIG. 2 is a schematic view 200 showing tenancy related events captured as tenancy history data 218 in accordance with one embodiment. Tenancy history data 218 may comprise new account data 202, good standing data 204, non-payment data 206, notices data 208 and settlement data 210 such as those related to legal actions, eviction data 212 and move out data 214 related to termination and collection data 216 related to enforcement.

Persons of skill in the art will appreciate that the method(s) and system(s) described herein may be implemented using programmed processors (e.g. via memory storing instructions and data therefore) of one or more computers such as in a server/client relationship. The application and graphical user interface discussed herein may be provided via a web browser or a native application. Tenancy history data 218 may be stored to a database or other store coupled to a computing device.

Tenancy related data is compiled for particular tenants (e.g. specific individuals in a residential rental context) and stored in central store such as a database. Property managers (typical users of the systems) are provided an interface, operable via client computing devices (e.g. laptop, desktop, tablet, PDA, smartphone, etc.) to input tenancy related data for their respective tenants. The data is compiled in a way that associates the data representing the events to a particular property and tenant.

To provide increased efficacy, tenancy related data compiled in the system for a particular tenant by one property manager is associated with tenancy related data compiled in the system for the particular tenant by another property manager thereby to build up a truer tenancy history for the tenant as the tenant may move from property to property. Such data is preferably shared among property managers for searching and score calculating purposes.

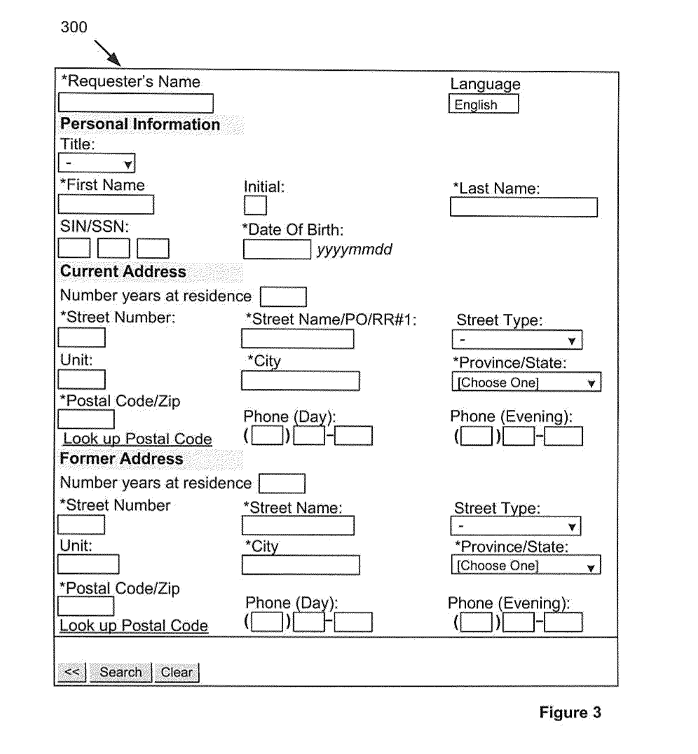

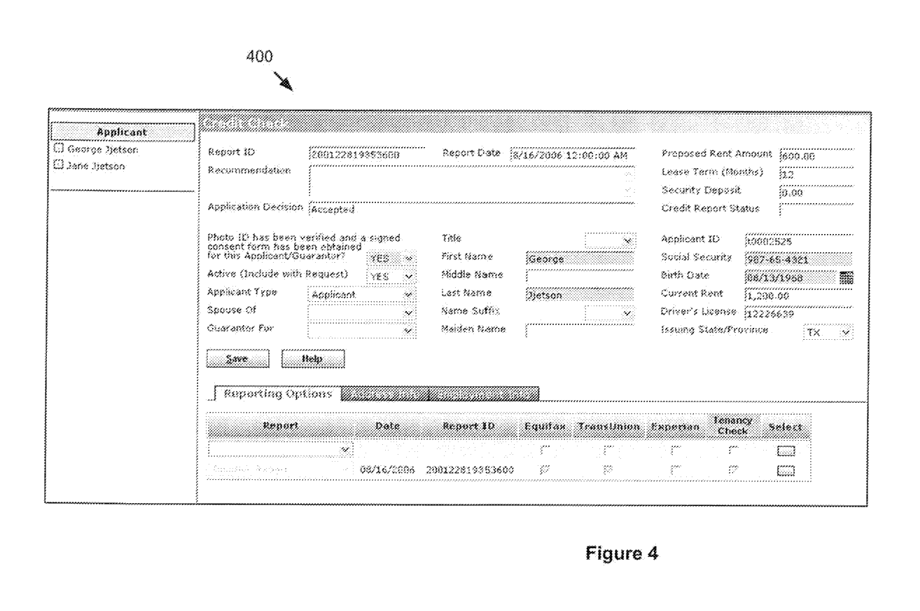

In one embodiment, for example as a portion of component 102, users are provided an interface 300 for searching information about a prospective tenant (see FIG. 3). The searches result in a report that may be comprised of merged information from many sources, the information including for example, tenancy histories and related scoring, credit histories and related scoring. Interface 300 provides fields for inputting user identification data including name, birth date, social insurance number/social security number, and recent residence addresses and telephone numbers to assist with the search. A searchers name and/or ID may be provided. Different language interfaces can be provided. Search interfaces and reports can be made available through the user's property management (PM) system interface (described further herein below) as in interface 400 of FIG. 4.

The provider of the credit history and related scoring information may be the same or a related entity to the entity that is providing the tenancy history and scoring data (i.e. such that the credit data is not “third party” data). Third party information can be optionally combined and merged with credit history information and/or tenancy history information along with criminal and other information and co-mingled in a merged background report.

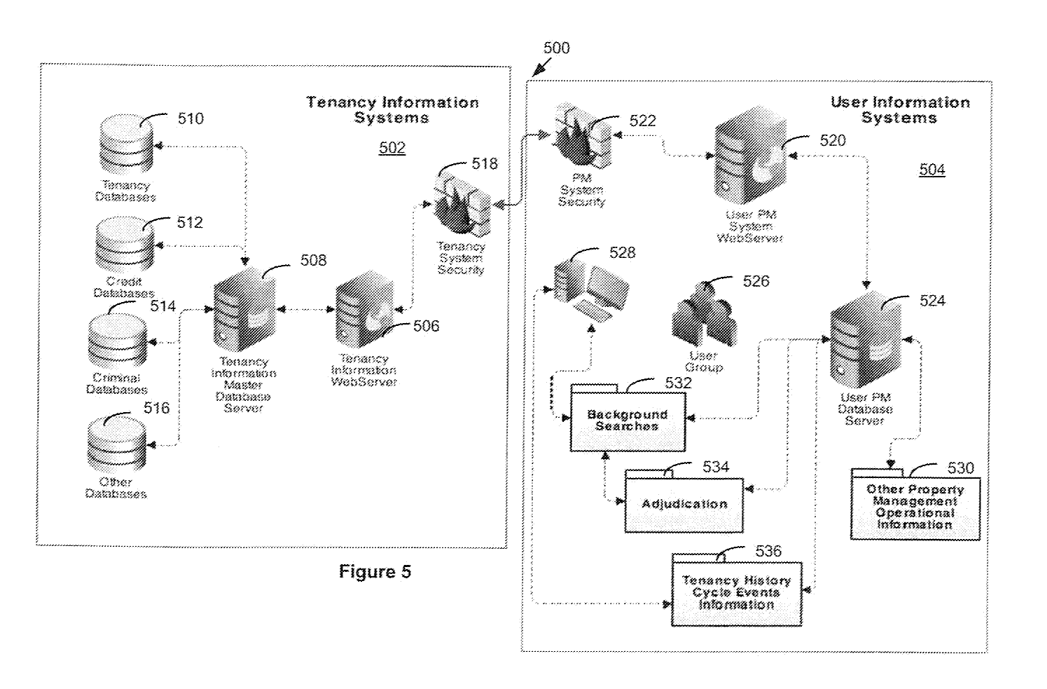

In accordance with one embodiment in FIG. 5, there is an example system-to-system configuration 500 comprising a tenancy information system 502 and a property management (PM) system 504 (i.e. as a client user information system for server system 502). In the present embodiment, the systems communicate via a Web-interface. IT is appreciated that the configuration 500 is simplified.

Tenancy information system 502 comprises a tenancy information Web server 506 with an interface to a tenancy information master database server 508. Database server 508 is coupled to information stores, which may or may not be third party information services (as noted above). For simplification, they are all represented as databases. Information stores comprise tenancy databases 510 for storing tenancy history data 218, credit databases 512 providing credit data and scores, criminal databases 514 for providing law enforcement related data and other databases 516. A tenancy security system 518 may front the tenancy information server as is well known.

Tenancy information system 502 may be configured to provide components 102, 104 and 106. In the present embodiment, it is configured to provide one or more interfaces to a PM system 504. The interfaces may receive search requests, adjudication results and other tenancy history data from PM system 504 as well as provide search results and one or more graphical representations of various tenancy history data back to PM system 504.

Though not shown, tenancy information system 502 may be configured to provide an interface to tenants, for example, to enable a tenant to perform requests to view the tenant's respective tenant history data. In one embodiment, the tenancy information system 502 may be configured to provide an interface to tenants and others for sharing information about tenancy experience, landlord and/or property recommendations, etc. such as via a social networking and/or electronic bulletin board system.

PM system 504 comprises a PM system Web server 520, a PM security system 522, a PM database server 524, a representative user group 526 (i.e. property managers) and a representative user computer 528. PM database server 524 can provide access for user group 526 via computer 528 to various PM applications (not shown) and information (e.g. 530) for managing properties. In the current embodiment, PM database server 524 provides access to the user group (e.g. via computer 528) to tenancy information system 502. The user group may perform respective background searches 532, perform adjudication of applications 1334 and provide and/or receive tenancy history data and related tenancy life cycle event information 1336.

A PM application (software product) or service can be licensed to a PM company for its users and therefore is very much a standalone system, which may provide the ability to manage new tenancy applicants, report adjudication decisions, automate lease document production and account for rental income receivables. At a click of a button the interface allows a user of such PM system to automate ordering background checking and obtain an instant report. The software behind this function gathers the required search information from a tenancy applicant's or leasing agent's completion and submission of an online rental application, interfaced to the user's PM system remotely and in a secure manner. The PM system 504 (client-side) sends the search criteria, such as: tenancy applicant name, address, date of birth, and adjudication ID code to be used later along with a request to the server-side system 502. The tenancy history information server 508 performs the search, and returns the data via Web server 506 to the user's PM system 504 for display on a screen (e.g. of computer 528) as a report (e.g. 532). The PM system 504 then waits for adjudication status input by a user (526). The benefits of data input accuracy, and significantly picking up the pace of leasing vacant premises for large corporate users, is accomplished by saving the operations of logging into a (separate) website interface with all it's error prone possibilities to an increased input accuracy, convenient system-to-system request and report delivery initiated by a tenancy applicant online.

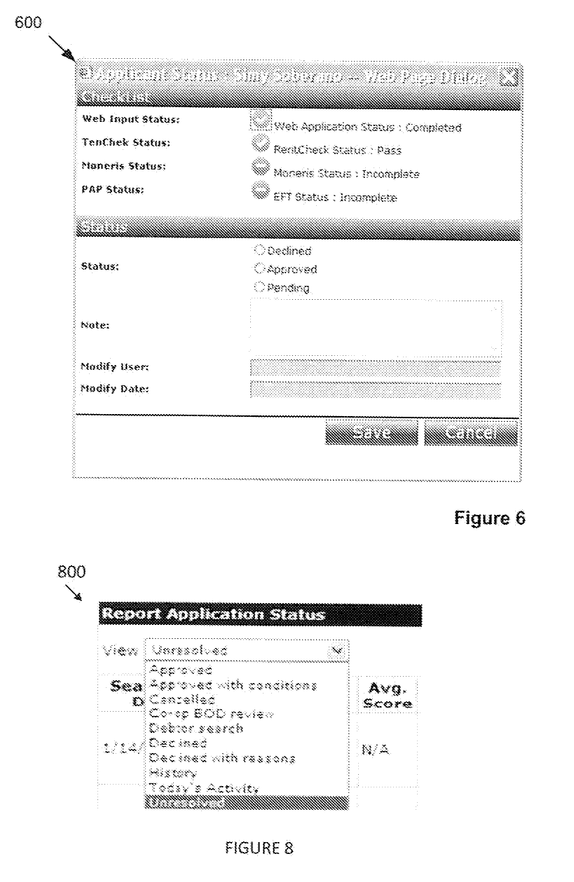

After delivery of reports (e.g. 432), the system-to-system automation provides for automatic upload of adjudication decisions as described further herein below. An adjudication ID code (not shown) tagged to the initial background search is sent when the user reports adjudication through PM system 504 as in interface 600 of FIG. 6, which adjudication ID code is matched to the initial search conducted on the tenancy applicant reducing the entry of adjudication status to one procedure within the user's PM system.

In addition to the search facility and upload of adjudication decisions, in accordance with the present embodiment shown in FIG. 5, ongoing tenancy cycle of events data (see FIG. 2) is also uploaded in a regularly scheduled computer generated delivery of information from the PM system 504 to the tenancy information system 502. All in all, the objective of the system-to-system function is to produce a very high efficiency-producing lease processing structure.

In addition a web-based graphical user interface is provided where the code behind the interface is the engine that drives this program method and model. As in FIG. 1 the consumer and commercial search activities initiates the cycle. Secondly, upon completing a background search, users can optionally report whether an applicant was approved or declined. A user who has completed a search and more than 7 days after doing so attempts to conduct a new search without optionally reporting is deemed to have an outstanding adjudication decision to report. In accordance with an embodiment, to enhance data capturing, the system is configured to require a user to enter outstanding adjudication decisions before proceeding to complete a new search. The system refers to this as the Mandatory Adjudication Reporting (MAR) rule, which forces the user to enter the actual adjudication decision (e.g. via interface 600).

To assist with tenancy application granting, many property managers seek consumer and/or commercial background information such as credit ratings and credit history information, criminal or general background check for customer information verification and credentialing. Service providers of such background credit-related information have made available on-line interfaces (e.g. Web-based) for requesting and receiving this background information.

In accordance with one embodiment, the system and method of the present invention is integrated with such an on-line interface. A credit-searching interface is configured to allow users to enter personal information to conduct a consumer and/or a commercial background search as in FIG. 3. This sets the stage for verification of completed tenancy application adjudication records.

A particular user of the on-line interface may be a property manager conducting a search for background information about a prospective tenant in the context of an application for tenancy at a particular property. To facilitate searching and associating the search with a specific rental property, the user's account may have a simple search account associated with only one rental property or, the user's search account could be associated with many rental properties, where the user selects from a multi-view pull-down list of a portfolio's properties to match the specific rental property associated with the tenancy application. The user then proceeds to conduct the search. However, the user may have previously conducted a search and undertaken a tenancy application adjudication for the same or a different tenant which tenancy application adjudication result is not updated in the system. The adjudication result for that prior search and application remains outstanding, particularly in system 502. It is assistive to close open searches so that new tenancies may be established within system 502 so that tenancy history data may be compiled for the new tenancy.

Before the system allows the user to continue with entering the name of the new applicant for a new search, the program automatically performs an unresolved adjudication test for the user's account.

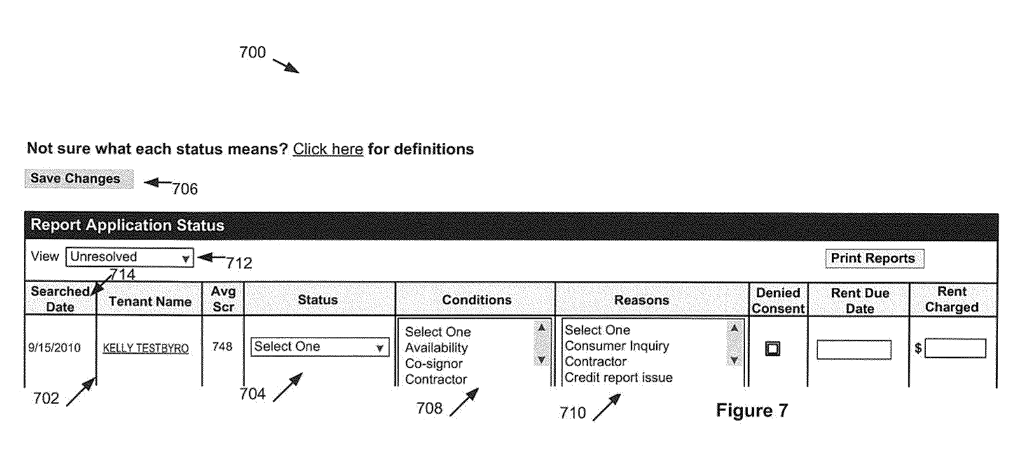

Upon detecting that the user has signed on and the system has one or more unresolved tenancy applications from prior searches, an Adjudication Interruption Window illustrated in interface 700 of FIG. 7, automatically opens in place of the search window and takes over the screen.

The report application status interruption window defaults to a list of the user's unresolved applications 702 sorted in descending date order. The user may select an unresolved application and, via a drop down menu 704, further select the applicable adjudication status (result). A Save Changes button 706 may be invoked to update the changes. The various status options are described further below.

Some adjudication results require further details or specificity and the interface may be configured with the ability to select more than one condition or reason for an event; such as, approved with conditions where the user must choose one or more conditions from the conditions menu (e.g. 708) before saving the changes, or if declined with reasons is selected the user must choose one or more reasons from the reasons menu (710) in order to save the changes.

The system organizes and maintains adjudication information history for twenty (20) years so users can view or edit past adjudicated applications and are able to create custom management reports. Status types selected from the View pull down menu 712 found above the Searched Date 714 in FIG. 7 is expanded in interface 800 of FIG. 8 to aid in viewing records and creating reports by status type.

Sharing of this adjudication information by users in large property management operations increases the efficiency of processing multiple rental applications from a renter who might have applied at more than one of the landlord's buildings. As the system builds approved adjudication history, a positive record on a renter's file builds also and helps to improve a renter's credit rating and score.

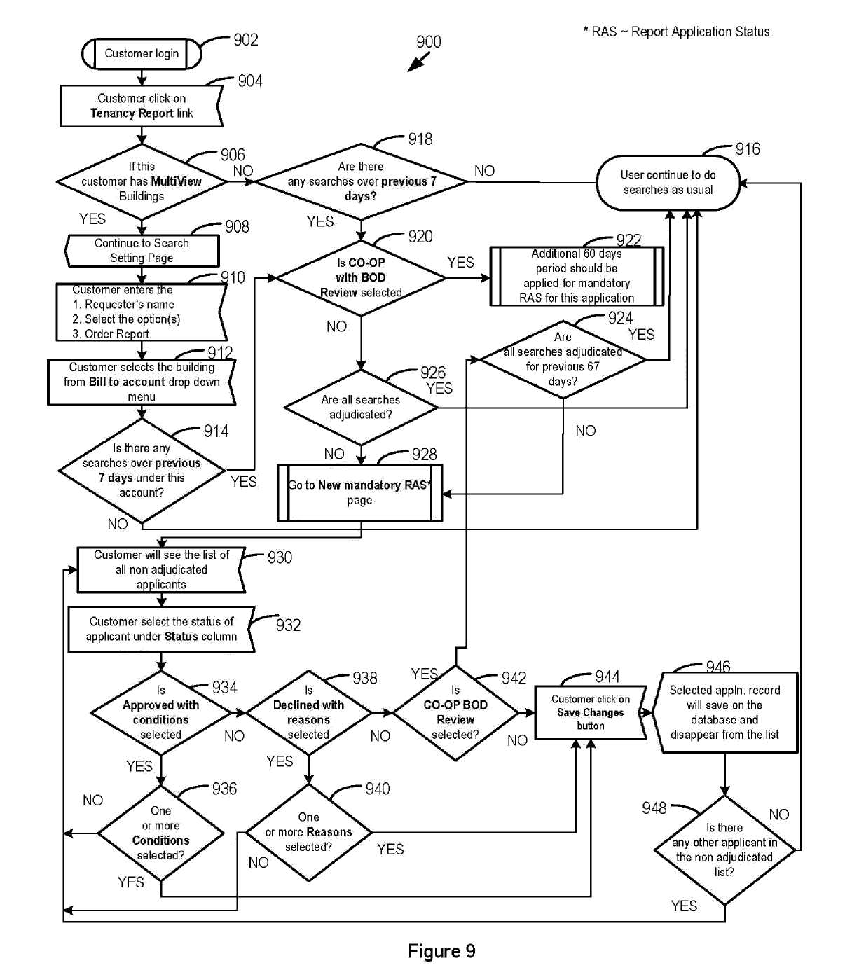

FIG. 9 is a flowchart illustrating operations of a method for the mandatory adjudication reporting when a rental property agent commences a new tenancy applicant background search. As described above, if unresolved adjudication decision(s) are discovered an interruption window pops up. The interruption window suspends the user's ability to complete the requested new search. Only until all outstanding adjudication decisions have been updated including other information like payment due date, is the interruption window removed and the user allowed to proceed to complete the new search. Only adjudicated applications with an approved decision results, will be selected as available to track since this infers the tenancy applicant is now a tenant.

The user interface, system and method provides pull-down menus for the user to make a selection of adjudicated decision options. An info icon link opens an explanation window for each adjudication decision as follows:
APPROVED allows the user who has fully reviewed a tenancy application has decided the applicant is a suitable tenant.
APPROVED WITH CONDITIONS allows for an explanation of any stipulations agreed to when the applicant was selected as a suitable tenant and can be expanded depending on real life situations. This option is mostly associated with a co-signor or guarantor being approved.
DECLINED—After you have processed your usual review of an application for housing you decided the applicant is not a suitable tenant.
DECLINED WITH REASON allows for an explanation of why an applicant was not a suitable tenant and has a sub-menu of reasons which can be expanded depending on real life for example the following; no credit or rent history available, no guarantor or co-signor available, did not qualify for social housing, overqualified for social housing, credit report issue, selected another applicant from several good candidates and tenancy report issue.
CO-OP BOD REVIEW is provided for social housing organizations and when selected an additional 60-day reporting period allowance is applied making a total of 67 days before the interruption window appears. This period involves the user waiting for a formal review by a housing committee and/or Board of Directors (BOD).
CANCELLED is provided when the applicant withdraws the application or for any reason that may require an application be abandoned for example cancelled by applicant.
DEBTOR LOCATE SEARCH—Reporting the adjudication decision is not necessary as this search is for collection purposes where the search output provides information only to the user and is not associated with an adjudication decision.

Other selections can be added depending on a user's realities.

With reference to FIG. 9, operations 900 begin with customer login 902 and initiation of a tenancy report inquiry (904). At 906, a determination is made whether the customer has multiple buildings. If no multiple buildings, operations continue at 918 described below. If yes, at 908 operations continue to configure the search setting page (parameters) for the search. At 910, requester name and information is entered and a report type selected for ordering. At 912, the customer selects a building from a “bill to account” drop down menu. At 914 a determination is made whether there are any previous searches outstanding for more than a threshold such as a number of days (e.g. 7) associated with the account. If no outstanding searches requiring adjudication information, operations continue at 916 to perform additional searches, if applicable.

If one or more adjudications are outstanding, operations continue at 920. Similarly, at 918 for single building customers, a determination is made whether there are outstanding searches over 7 days. If yes, at 920, a determination is made whether the application is pending review such as by a co-op board. If yes, at 922 further time is given to the search for adjudication (e.g. 60 days). At 924 a review of similarly postponed searches determines whether there are any outstanding for more than 67 days. Operations branch to 916 if all searches are adjudicated (yes branch) and to 928 for mandatory adjudication reporting if not. Operations at 926 determine whether there are outstanding searches and branch to 916 if not and to 928 for mandatory adjudication reporting if there are.

For mandatory reporting of application status interface 700 may be presented and at 930 the customer is presented with the list of non-adjudicated applicants. A status is selected (932). If the approved with condition status is selected (yes branch from 934) a determination is made whether conditions are selected. If no, operations return to 930 for selecting another applicant, for example, or to complete the present applicant through additional input. If the condition is selected, operations branch to 944 for saving changes.

If the applicant is not approved with conditions, the applicant may be declined with reasons selected (938). If yes, one or more reasons may be selected 940. If yes, operations branch to 944 and to 930 if not.

If not declined, the application may be with the co-op board (942). If not, operations branch to 944 but if yes, branch to 924 previously described.

At 944 results input are saved. At 946 the database is updated and the view presented in interface 700 updated to remove the applicant. If additional applicants remain (948), operations return to 930 for further updating of applicant status or branch to 916 to permit further searching.

Though not referenced in FIG. 9, payment due date information is provided with adjudication information. The payment due date is calculated as the first day of the following month but is allowed to be overwritten by the user if the calculation is incorrect. This date is key to automating the ongoing tenancy history reporting system.

This payment due date is auto-populated for each subsequent pay period until the tenant moves out. The regular rent amount is not mandatory but when entered the system carries the amount throughout the tenancy history until a default event occurs when it is necessary.

By knowing which tenancy applicant was approved and the payment due date, the third component 106 of the system's methodology of tracking tenancy history, i.e. compulsory tenancy history reporting, can now begin as depicted in FIG. 2.

Upon a user signing on (for example according to one embodiment), in addition to applying the mandatory application reporting (MAR) rule described above, the system then executes a Compulsory Tenancy History (CTH) reporting rule for each of the user's tenants having an approved decision, who moves in, and where the tenancy has not been terminated.

As certain information is derived from the search entry, such as tenant name and address identification, landlord information is derived from stored and previously created customer information.

The CTH rule commands the operation of a dynamic emailing system that sends emails to landlords on the 6^{th} day after the payment due date, and is executed once for every rental period, whether monthly, bi-weekly or weekly for newly approved and past approved tenants. All the adjudication decision entries are saved in the database 510, as well as the reported tenancy applicant's full name, address and other data related to the tenancy when a delinquency event occurs.

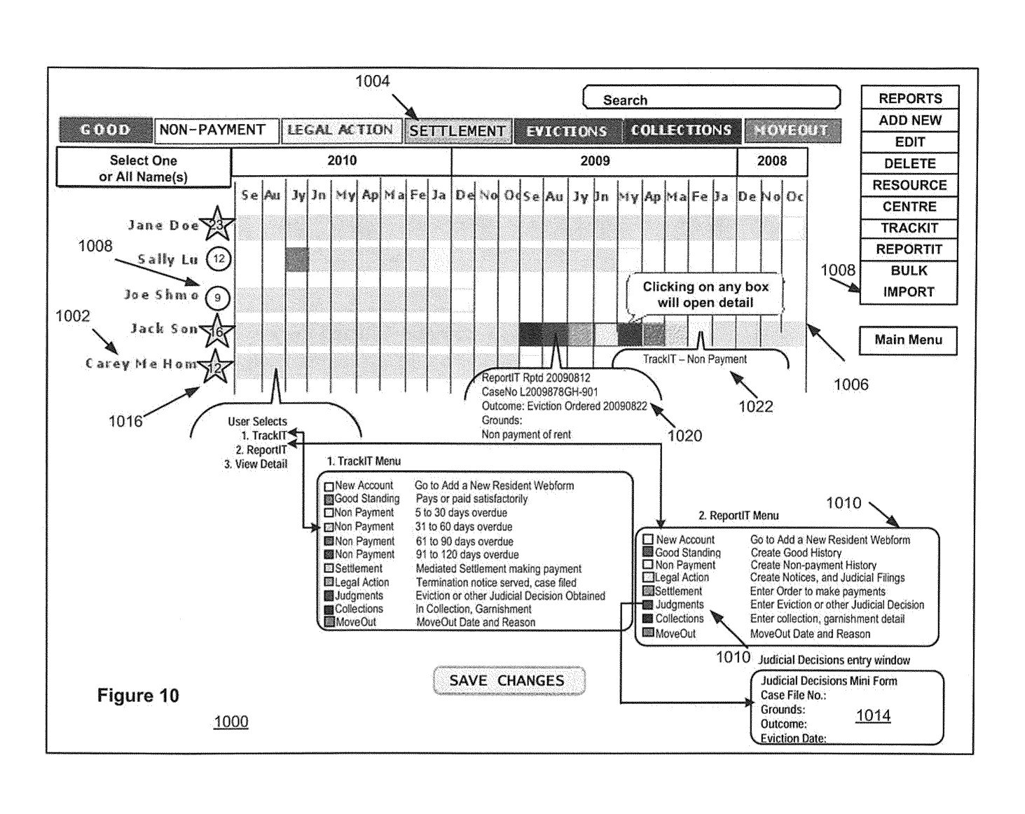

To quickly create the payment due date used by the CTH rule and system described herein accommodates the ongoing processing of monthly payments and defaults to the 1^{st} day of the month following the approved adjudication date as follows; if approved date is on the 12^{th} day the payment due date automatically defaults to the 1^{st} day of the following month. After viewing the defaulted payment due date the user can ignore it as being correct or change it to a different actual payment due date. If the date is changed the final user operation is to click the Save Changes button (e.g. 706 in interface 700) or in an interface for viewing and updating a tenant's tenant history data such as shown in FIG. 10 described herein below.

In accordance with an embodiment, when the user has no need to do a search on or after the next 6^{th} day of a month following, or they may forget to update the rental history for that month and for many pay periods later, the system continues to email notifications with an optional link allowing a user to report a default or to ignore the notification email because all is in good standing. The user is able to update unreported rental history status for all periods missed if necessary and notifications provide the number of months reported as information for the user. Content for email notifications is predefined to solicit action by the landlord and progressively become more serious until notifications and updating cease 12 months after the last user activity.

Only when an amount is present as the regular rent charged will the system carry it over to subsequent rental periods, and auto populates the amount due for every month as it comes due and auto populates the amount paid for each period accordingly. When the user proceeds to report a default the amount paid changes to zero so the user can over write a partial amount paid. If the tenant pays more on another date the user is able to overwrite the amount paid and date paid to reflect a default or update event.

Amounts are always treated with an over writing feature but the history of each amount paid and date paid in a historical outstanding amount field creates a more complete trail of actual payment history. The total of all the payments is compared against the amount due for that month.

If the user ignores the emailed positive update reminder(s) and does not report at all, then a good standing default report that the payment was satisfactorily paid will continue to be automatically reported thusly. Users are only obliged to report when a delinquency event occurs.

FIG. 10 represents a tenancy history reporting graphical user interface home page 1000 for example for use by users of PM system 504. In the present embodiment, the home page may be configured to show respective tenants (e.g. 1002) by various present status 1004 such as good standing, non-payment, legal action, settlement, evictions, collections, move out. Tenant history data may be presented in a timeline section 1006 by payment period (e.g. month) and colour coded to represent the status (good standing, non-payment, etc.) in each period.

Selecting a specific payment period (e.g. 1020, 1022), a user may view details (specific history data) concerning the status, may invoke selections update the history data, etc.

In addition to the home page interface 1000 other interfaces for inputting data (not shown) may be provided. For example an interface may be provided to bulk upload data (e.g. invocable via control 1008) from PM system 504 such as when a new PM customer is added to system 502 or a new building is acquired by a current PM customer. XML or other electronic data exchanges may be performed as is well known.

Upon opening the home page (FIG. 10) for each month that shows the good standing records for a particular tenant (e.g. 1002), the user can report and track other charges and deposits, such as last month rent deposit, or utilities in rental history reporting to confirm if these have been paid as well as any legal action that has occurred for non-payment or incident violation event(s) such as the following multi-selection enabled pull-down menu (not shown) provides:

| | |
|---|---|
| 1 | Abandoned Rental Unit |
| 2 | Damaged Rental Unit |
| 3 | Illegal Act, Drugs |
| 4 | Illegal Act, weapons |
| 5 | Illegal Act, other |
| 6 | Impaired Safety |
| 7 | Impaired Safety caused fire |
| 8 | Interfered With Enjoyment |
| 9 | Overcrowding |
| 10 | Sheriff's/Bailiff's Repossession, Eviction |
| 11 | Tenant Refused Entry to Show |
| 12 | Unauthorized Occupant(s) |
| 13 | Ministry of Health inspection |

The system and method tracks the outcome of court cases using a sub-form, which identifies grounds for reporting, selected from a pull-down menu. The system provides for any action taken to enforce a judicial decision such as reported to a collection agency, garnishment, or for eviction enforcement. The grounds for reporting multi-selection pull down menu (not shown), as follows, can be expanded to accommodate user realities.

| | |
|---|---|
| 1 | Abandoned Rental Unit |
| 2 | Ceased to Qualify |
| 3 | Damaged Rental Unit |
| 4 | Demolition, Conversion, Repairs |
| 5 | Employment Ended |
| 6 | Illegal Act |
| 7 | Impaired Safety |
| 8 | Interfered With Enjoyment |
| 9 | Landlord's Rights |
| 10 | Misrepresented Income |
| 11 | Non-payment of Rent |
| 12 | Non-payment of Utilities |
| 13 | Overcrowding |
| 14 | Over-holding Subtenant |
| 15 | Persistently Late |
| 16 | Purchase Agreement Terminated |
| 17 | Rehabilitation |
| 18 | Repossession Eviction |
| 19 | Super Employment Ended |
| 20 | Tenant Agreed to Terminate |
| 21 | Tenant Gave Notice |
| 22 | Unauthorized Occupant |
| 23 | Water Testing Charge |

An example of selecting a sub-form named Judgments 1010 from the ReportIT menu 1014 in FIG. 10 invokes a judicial decisions entry window 1012. Each ReportIT menu box invokes a corresponding entry window.

The following table lists the number of interrelated sub forms of the CTH reporting system used for entering information;

| | |
|---|---|
| 1 | New Tenancy Account Creation or Update Information |
| 2 | Good Standing Creation or Update Information |
| 3 | Non-payment Creation or Update Information |
| 4 | Legal Action Creation or Update Information |
| | a) Legal forms for notices and court filings |
| 5 | Settlement or Mediation Creation or Update Information |
| 6 | Judicial Decision Creation or Update Information |
| 7 | Move Out Creation or Update Information |
| 8 | Collection Creation or Update Information |

In one embodiment, the system and method provides for adding existing or former tenants in the New Tenancy Account Creation selection of the ReportIT menu to allow a user to track all current and past tenancies. This feature permits the establishment of tenancy history even if the tenancy grant was not adjudicated via the property management system.

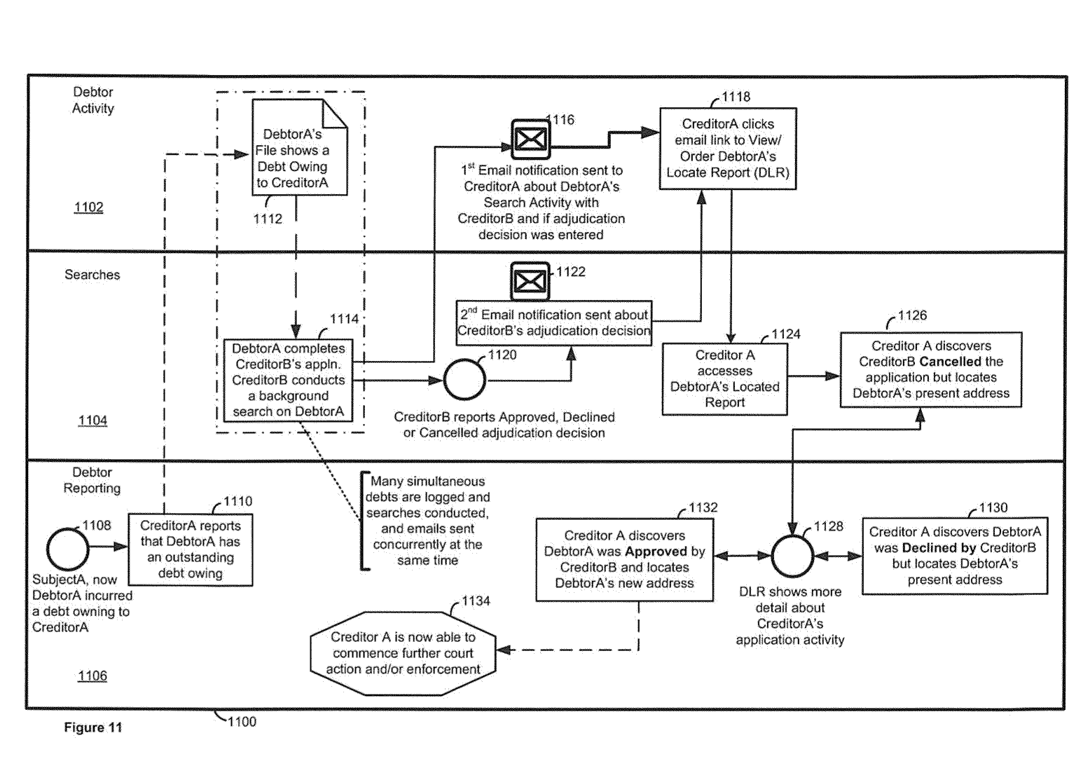

Adding a tenant or former tenant may also involve reporting of past histories where ex-tenants may owe debts to the landlord, which could have occurred years ago. The collection activity, as depicted in FIG. 11, allows users to monitor debtor activity and get email notifications when the tenancy information system 502 has detected a search or adjudication activity or an addition of a new tenancy account (new tenancy history) described above. Debtors that owe to prior landlords are now detected and all prior creditor landlords are automatically notified by email. Who is involved in this debtor activity and the debtor's address detail can be retrieved through a debtor's locate report (not shown). A link in the email provides quick access to the user's account and debtor locate report request.

With reference to FIG. 11, there is shown a flowchart of activities/operations 1100 of a method of monitoring and notifying of debtor activities to facilitate enforcement action. There is shown debtor activity 1102, search activity 1004 and debtor reporting activities 1106. At 1108 a person, DebtorA (e.g. a particular tenant tracked in system 502), incurs a debt owing to CreditorA. At 1110, Creditor A reports outstanding debt. At 1112, DebtorA's file shows a debt owing to CreditorA. At 1114, DebtorA completes a tenancy application with CreditorB and CreditorB conducts a background search such as described above. At 1116, an email notification is triggered to alert CreditorA of the activity with CreditorB, such as the adjudication decision. CreditorA may click the link in the email (1118) to view and/or order a Debtor Locate Report for DebtorA.

At 1120 CreditorB updates the adjudication decision. A second email is sent to CreditorA (1122) which may be invoked (1118). At 1124, CreditorA accesses the debtor locate report for DebtorA. CreditorA determines the current address of DebtorA 1126 for a cancelled application. For other adjudication results, the report may show additional information about the application activity (1128). At 1130 and 1132, CreditorA determines the respective adjudication status and address of the debtor. At 1134, CreditorA commences further enforcement activities in accordance with the new address information. Though described with reference to debtor monitoring and detection, an embodiment of the system and method herein may be adapted for tracing other persons in different contexts. For example, a watch service may be implemented. Through an interface, (not shown) a PM user or other requestor may provide a name and other identifying information of a person of interest to system 502 and request notification of any update or other activity within system 502 in relation to the person of interest. If the person of interest is of record in system 502, the requestor may perform a look up and select the person of interest for the watch service. In a similar manner as shown in FIG. 11, email or other notification of activity may be communicated to the requestor, using the new activity as a trigger. The requestor may then locate the person of interest in response to the look-up and/or new activity, noting new address or other information to trace the person.

An easy method to add existing tenants to the list of tenants being tracked is provided and allows the creation of a bulk data contribution function for uploading a spreadsheet of information or other data file types of debt owing information, which is added to the database to allow monitoring of debtors as in FIG. 11.

When a move out date, reason and reference entry is completed upon the expiry of the move out date, the compulsory reporting for the associated tenant stops as the now ex-tenant has vacated and there is no other reporting the user or system needs to maintain. A vacancy prompts the landlord to start advertising for another occupant, which starts the order of events of adjudication and tenancy history reporting as in FIG. 2. Move out reasons and references are presented in a pull down multi-selection manner on the move out sub-form and are expandable to accommodate user realities as follows.

| | |
|---|---|
| *Reason: | □Became a homeowner |
| | □Damages Related |
| | □Death of tenant |
| | □Employer paid termination |
| | □Employment ceased with landlord |
| | □Eviction Related |
| | □Left due to job relocation |
| | □Left to live with family |
| | □Lost employment |
| | □No reason given |
| | □Non-payment Related |
| | □Lease expiry limitation |
| | □Other . . . |
| *Reference: | □Couldn't ask for a better tenant |
| | □Good standing |
| | □Great tenant very respectable |
| | □Helpful, friendly, excellent resident |
| | □Would definitely rent to this person again |
| | □Always paid on time |
| | □Payments made satisfactorily |

In one embodiment, the system and method described herein are configured to provide a tenant rewards program for landlords who are responsive to the tenant's respective tenancy history. Many organizations today have loyalty programs that reward customer tenants with various benefits for renting their premises, paying on time, and purchasing products and services. A reward points program can be configured by exploiting the good standing histories to distinguish tenants with positive tenancies from negative ones based on overall performance. For example rent paid on time every month for a period of 12 consecutive months and that the tenant is in good standing produces a gold star 1016 as in FIG. 10. Gold star tenant records can be converted to a reward program where points can be redeemed for goods, services, home purchase deposit, and rent payment credits. The gold star program automatically enables users to keep track of who is in good standing and paying on time for at lease twelve consecutive months.

A circle 1018 replaces the star when a delinquency event occurs, or 12 consecutive months of on time payment has not been reached, or the consecutive pattern is interrupted by a delinquency. The circle contains the value of the total historical number of periods of good standing and paid on time showing in the center of the circle as in FIG. 10. When the tenant acquires another 12 consecutive good standings with on-time payments the circle again changes to a gold star.

Tenancy rating data (reward points) can be provided to tenancy information system 502 for storing to database 510 or 518. An interface (not shown) may be provided to tenants to view their respective tenancy history data, reward points, etc. The interface may be configured to permit a tenant to redeem the reward points electronically, such as to acquire products or services, etc.

As noted, tenancy history data and scoring may be useful to a property owner when adjudicating a subsequent application by a prospective tenant, for example, when the tenant desires to move to a new property. The background user interface may be configured to report tenancy history data and related scoring as well as other background information such as credit history reports. The background user interface may be integrated with the tenancy history user interface to capture new tenancy applications and adjudication results to maintain the compilation of tenancy history data. Sharing tenancy history data among property owners raises the potential completeness of history data for particular tenants with a view to raising efficacy of the tenancy history database and scoring which may be defined using such data.

In one embodiment, the system, method and business model herein are configured to provide for tenants to exchange their myriad of tenancy life cycle events and community based experiences and then be able to rate and submit a reference about such experiences with renting not only about the landlord but their whole life experience within the community, borough, district, City, State, Province or Country. Tenancy information system 502 may be configured to provide an interface for tenants to post such information for viewing by others. The interface may be supported by an application such as a social networking application or bulletin board application, among others. The information may be made available to others through linked third party services such as other social networks and third party information sharing platforms.

A tenant application process for applying on-line or other tenant inquiry process (neither shown), for example, provided either directly through tenancy information system 502 or through a PM system 504 communicating with tenancy information system 502 provides on-demand access for tenants to view their own files before commencing a new rent apartment search or for other personal reasons. In addition the rewards system as referred to herein is presented for tenants to view points accumulated, rewards obtained and ways to redeem their points. Such experiences and ratings are communicated to the renting community at large to allow a more local experience descriptive that can be shared with outliers who are contemplating a move to the community. The renter's local social network when linked to other Internet based social networks is able to create an integrated global ability to share landlord ratings, rental life styles and characteristics about what it is like to live among communities across the Internet. By sharing rent life cycle experiences in concurrence with tenancy history reporting, the aggregate effect of this network may create a pre-approval of a prospective tenant, which may eliminate the need for accessing a tenant's credit check. For rental housing applications, eliminating credit information from the approval process improves privacy protection and eliminates fraudulent credit information use by identity thieves.

We claim:

1. A method for compiling a tenancy history for a particular tenant comprising:
providing a tenancy history user interface configured to receive data representing tenancy events associated to the particular tenant and a particular property with which to define the tenancy history, the events comprising tenancy move in, periodic tenancy payment and tenancy move out, the tenancy history user interface further configured to receive search queries for displaying at least a portion of the tenancy history;
receiving and storing data representing tenancy events; and
receiving a search query and displaying the tenancy history in response thereto.

2. The method of claim 1 wherein the user interface is further configured to receive data representing tenancy adjudication associated to the particular tenant and the particular property with which to define the tenancy history.

3. The method of claim 1 wherein the tenancy history user interface is further configured to receive data representing tenancy events comprising one or more of: legal action, settlement, judgments, and collections.

4. The method of claim 1 wherein data representing a periodic tenancy payment comprises data representing one of payment or non-payment for a specific payment period.

5. The method of claim 1 wherein data representing a periodic tenancy payment comprises a payment due date with which to determine each specific payment period and further wherein the method comprises automatically storing data representing payment for a specific payment period unless overwritten via the tenancy history user interface.

6. The method of claim 5 comprising automatically sending notification to prompt inputting of data representing a periodic tenancy payment.

7. The method of claim 1 comprising providing a background information user interface for receiving search requests for background information for respective tenants; and presenting background information in response to such search requests.

8. The method of claim 7 wherein the background information user interface is integrated with the tenancy history user interface.

9. The method of claim 7 comprising associating a request for background information for a particular tenant with an application for tenancy at the particular property; and requiring an input of data representing a tenancy adjudication for the application thereby to initiate the tenancy history for the particular tenant at the particular property.

10. The method of claim 9 wherein the background interface is configured to prevent the initiation of a further search for background information while the input of data representing tenancy adjudication associated to an earlier search remains outstanding.

11. The method of claim 9 comprising automatically calculating a payment due date for a periodic tenant payment for initiating the tenancy history.

12. The method of claim 1 comprising notifying a creditor property owner of activity of the particular tenant wherein the particular tenant owes a debt to the creditor property owner as determined from the tenancy history for the particular tenant.

13. The method of claim 12 wherein the step of notifying is performed in response to one of a search for background information and the addition of a tenancy history for the particular tenant.

14. The method of claim 13 wherein the background user interface is configured to receive a tenant's current address to define a search request for background information and wherein the current address is made available to the creditor property owner.

15. The method of claim 1 comprising providing a tenant reward program for tenants responsive to the tenants respective tenancy history.

16. A non-transitory computer storage medium configured to store instructions for configuring a computer system to perform a method in accordance with claim 1.

17. A tenancy history system comprising:
a database storing data representing tenants, properties and tenancy-related events, where the tenancy-related events for a particular tenant are associated with a particular property thereby to define a tenancy history;
at least one computing device coupled to the database and configured to provide a user interface for:
receiving and storing data to said database thereby to define said tenancy histories; and
receiving search requests for tenancy information and providing responses using said database.

18. The system of claim 17 wherein the at least one computing device is further coupled to access consumer or commercial background information comprising at least one of credit history, credit rating, criminal record check, customer identification and credentialing and wherein the user interface is configured to:
receive a search request for information associated with a particular tenant; and
provide a response comprising said background information and said tenancy history information.

19. The system of claim 18 configured to provide access to users wherein a particular user is associated to one or more respective properties.

20. The system of claim 19 wherein the tenancy histories are shared such that a search request from a particular user provides a response comprising tenancy information associated with a property not associated with the particular user.
